(19) United States
(12) Patent Application Publication
(10) Pub. No.: US 2011/0146440 A1
(43) Pub. Date: Jun. 23, 2011

(54) MANIPULATOR ARM MECHANISM

(75) Inventor: YONG FENG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/761,525

(22) Filed: Apr. 16, 2010

(30) Foreign Application Priority Data
Dec. 22, 2009 (CN) 200910312026.9

(51) Int. Cl. B25J 18/00

(52) U.S. Cl. 74/490.1; 74/479.01; 74/490.07

(57) ABSTRACT

A manipulator arm mechanism includes a pivot shaft, a first arm, a second arm, and an actuator. The first arm includes a first end and a second end opposite to the first end. The second arm also includes a first end and a second end opposite to the first end. The pivot shaft is connected to the first end of the first arm, and the pivot shaft has a first axis. The first end of the second arm is rotatably connected to the second end of the first arm and rotates around a second axis, and an angle between the first axis and the second axis is between 0° to 180°. The actuator is connected to the second end of the second arm.

### BACKGROUND

1. Technical Field

The present disclosure generally relates to a manipulator arm mechanism.

2. Description of Related Art

With developments in manufacturing technology, manipulators are widely applied in environments considered hazardous or difficult for human operators. Manipulator arm mechanisms are the standard elements of the manipulator.

A commonly used manipulator arm mechanism generally includes a plurality of straight arms connected together to move in different directions, and perform operations using actuators such as cutting tools or clips installed on a distal end thereof. However, since the manipulator arm mechanism includes a plurality of straight arms, at least three joined straight arms are required to bypass an obstacle. Therefore, the manipulator arm mechanism has a complicated structure. Furthermore, when an object having an uneven surface is to be manipulated, the actuator requires frequent adjustments to overcome dimensional complications, thus inconveniencing operation.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of a manipulator arm mechanism.

FIG. 2 is similar to FIG. 1, but viewed from another aspect.

FIG. 3 is an exploded, isometric view of the manipulator arm mechanism of FIG. 1.

FIG. 4 is similar to FIG. 3, but viewed from another aspect.

FIG. 5 is similar to FIG. 1, but showing the manipulator arm mechanism in another position.

### DETAILED DESCRIPTION

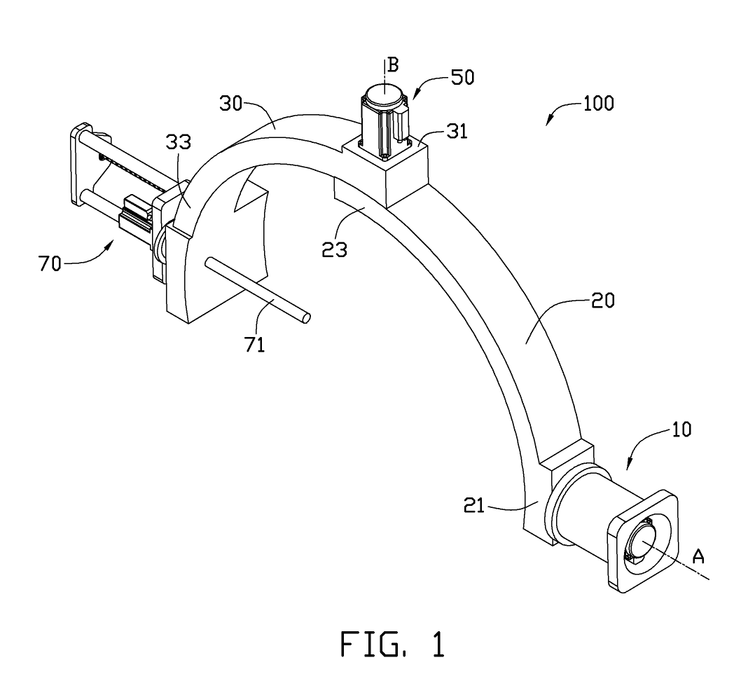

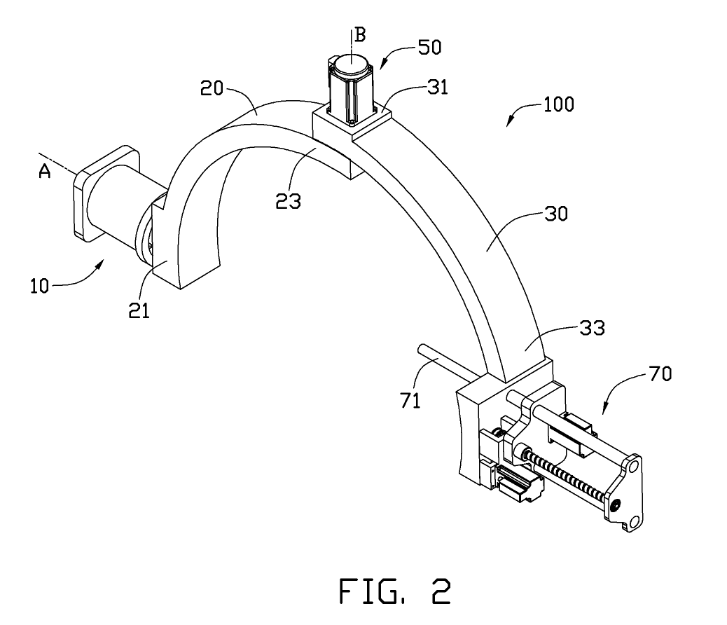

Referring to FIGS. 1 and 2, a manipulator arm mechanism 100 includes a pivotal assembly 10, a first arm 20, a second arm 30, a rotation assembly 50, and an actuator assembly 70. The pivotal assembly 10 is connected to one end of the first arm 20. The first arm 20 and the second arm 30 are curved and rotatably connected by the rotation assembly 50. The actuator assembly 70 is connected to a distal end of the second arm 30 and enables the performance of predetermined operations on an object.

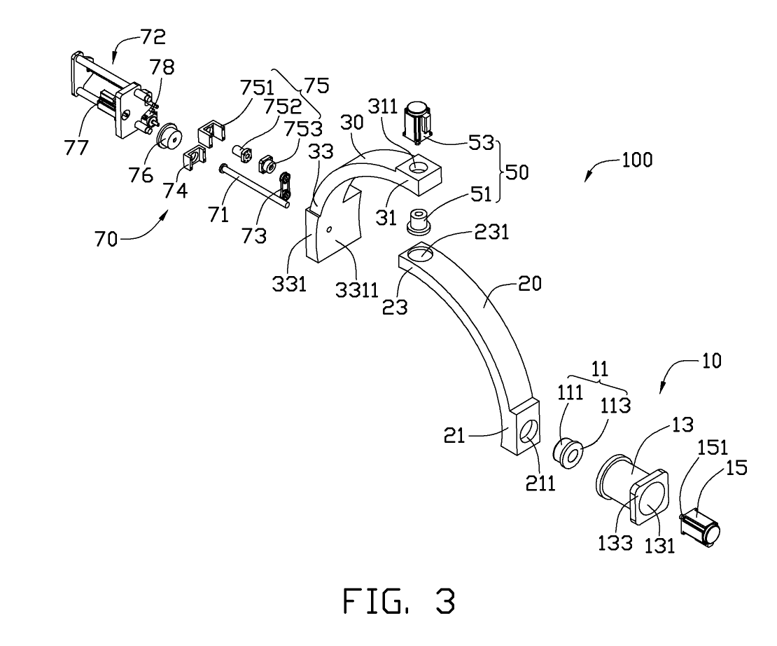

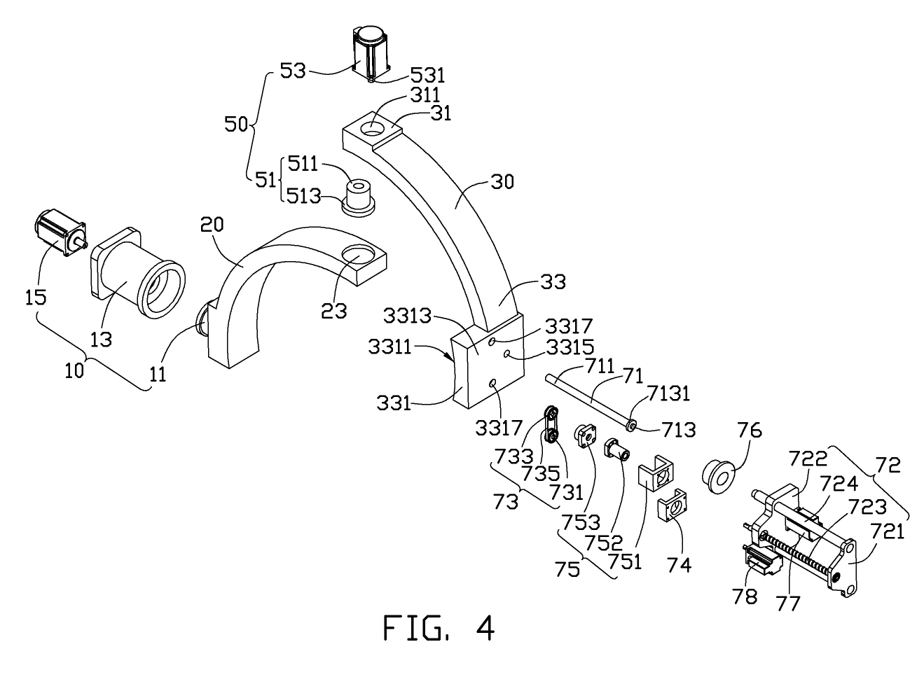

Referring to FIGS. 3 and 4, the pivotal assembly 10 includes a pivot shaft 11, a fixing member 13, and a driving member 15. The pivot shaft 11 is a stepped shaft having a first axis “A”, and the pivot shaft 11 includes a first shaft portion 111 and a second shaft portion 113. The fixing member 13 is a sleeve which defines a receiving hole 131 and forms a flange 133 on one end thereof. The fixing member 13 can be fixed to other equipment by means of the flange 133. The driving member 15 is received in the receiving hole 131 of the fixing member 13; and the driving member 15 includes an output shaft 151. In the illustrated embodiment, a diameter of the first shaft portion 111 of the pivot shaft 11 is less than a diameter of the second shaft portion 113, and the driving member 15 is a motor. It should be pointed out that the driving member 15 may also be a pneumatic cylinder or other types of driving member.

The first arm 20 includes a first end 21 and a second end 23 opposite to the first end 21. The first arm further defines a first pivotal hole 211 at the first end 21 and a second pivotal hole 231 at the second end 23. In the illustrated embodiment, the first arm 20 is a substantially arched bar with a central angle of 90°. The first arm 20 may be in the form of other curved structure such as a bow.

The second arm 30 includes a first end 31 and a second end 33 opposite to the first end 31. The second arm 30 further defines a third pivotal hole 311 at the first end 31 and forms a connection portion 331 at the second end 33 thereof. The connection portion 331 includes a curved surface 3311 and a flat surface 3313 opposite to the curved surface 3311. The connection portion 331 further defines a through hole 3315 and two blind holes 3317 recessed from the flat surface 3313. In the illustrated embodiment, the second arm 30 has a substantially arched structure with a central angle of 90°, such that the first arm 20 and the second arm 30 cooperatively form a semicircle when connected by the rotation assembly 50. The second arm 30 may be in the form of other curved structures such as a bow.

The rotation assembly 50 includes a pivot shaft 51 and a driving member 53. The pivot shaft 51 is a stepped shaft having a second axis “B”; and the pivot shaft 51 includes a first shaft portion 511 and a second shaft portion 513. The driving member 53 includes an output shaft 531. In the illustrated embodiment, a diameter of the first shaft portion 511 of the pivot shaft 51 is less than the diameter of the second shaft portion 513, and the driving member 53 is a motor, and may also be a pneumatic cylinder or other types of driving member.

The actuator assembly 70 includes an actuator 71, an adjustment unit 72, a transmission unit 73, a support member 74, a holding unit 75, a joint member 76, a first driving member 77, and a second driving member 78.

The actuator 71 includes an operation end 711 and a connection end 713. The connection end 713 forms a positioning flange 7131. The actuator 71 may be a drill, tap, clip, cutting tool, or other types of tools.

The adjustment unit 72 includes a first plate 721, a second plate 722, an adjustment member 723, and two guide members 724. In the illustrated embodiment, the first plate 721 and the second plate 722 are positioned substantially parallel to each other, and the adjustment member 723 is a threaded bar. A first end of the adjustment member 723 is rotatably supported by the first plate 721, and a second end of the adjustment member 723 is passed through and engaged with the second plate 722. A first end of each guide member 724 is fixed on the first plate 721, and a second end of each guide member 724 is passed through the second plate 722. The second plate 722 is capable of sliding relative to the guide member 724. The number of guide members 724 may be at least one or more than two.

The transmission unit 73 includes a driving wheel 731, a driven wheel 733, and a transmission member 735. The transmission member 735 transfers the rotation of the driving wheel 731 to the driven wheel 733. In the illustrated embodiment, the driving wheel 731 and the driven wheel 733 are both belt pulleys and the transmission member 735 is a belt. Alternatively, the transmission unit 73 may include two sprocket wheels and a chain engaging the sprocket wheels correspondingly or a pair of gears engaging each other.

In the illustrated embodiment, the support member 74 is a bent plate including a base portion (not labeled) and two extending portions (not labeled) extending substantially perpendicular from opposites sides of the base portion. It should be noted that the support member 74 may be replaced by a hemispherical case.

The holding unit 75 includes a support body 751, a first sleeve member 752, and a second sleeve member 753. The support body 751 is also a bent plate including a base portion (not labeled) and two extending portions (not labeled) extending substantially perpendicular from opposite sides of the base portion. It should be noted that the support body 75 may be replaced by a hemispherical case.

The joint member 76 is a stepped shaft defining a through hole along an axis.

The first driving member 77 and the second driving member 78 are both motors in the illustrated embodiment, and both may be replaced by rotation pneumatic cylinders or others.

During assembly of the manipulator arm mechanism 100, the driving member 15 of the pivotal assembly 10 is received in the receiving hole 131 of the fixing member 13, and the second shaft portion 113 of the pivot shaft 11 is also received in the receiving hole 131. Thereby, the output shaft 151 of the driving member 15 is received in an engaging hole (not labeled) defined in the second shaft portion 113 of the pivot shaft 11. The pivotal assembly 10 is rotatably connected to the first end 21 of the first arm 20 by the first shaft portion 111 being received in the first pivotal hole 211 of the first arm 20. Therefore, the first arm 20 is capable of rotating relative to the pivotal assembly 10 in a specific direction, for instance, relative to the pivotal assembly 10 around the first axis “A”.

The second shaft portion 513 of the pivot shaft 51 of the rotation assembly 50 is received in the second pivotal hole 231 of the first arm 20, and the first shaft portion 511 of the pivot shaft 51 is received in the third pivotal hole 311 of the second arm 30. The output shaft 531 of the driving member 53 is received in an engaging hole (not labeled) in the first shaft portion 511 of the pivot shaft 51. Thus, the first arm 20 and the second arm 30 are rotatably connected by the rotation assembly 50. The second arm 30 is capable of rotating in a specific direction relative to the first arm 20. For instance, around the second axis “B”.

The first end 31 of the second arm 30 is connected to the second end 23 of the first arm 20, and the second end 33 of the second arm 30 is free. An angle between the first axis “A” and the second axis “B” is between 0° to 180°, that is, the first axis “A” and the second axis “B” intersect or are on different planes. Since the first arm 20 is capable of rotating around the first axis “A” and the second arm 30 is capable of rotating around the second axis “B”, the second arm 30 is capable of rotating around two directions relative to the pivotal assembly 10. In the illustrated embodiment, the angle between the first axis “A” and the second axis “B” is 90°. Alternatively, the second arm 30 may be joined to a sidewall of the first arm 20, in this situation, the first axis “A” and the second axis “B” are in different planes.

During assembly of the actuator assembly 70 to the connection portion 331 of the second arm 30, the first sleeve member 752 of the holding unit 75 passes through the support body 751; and the first sleeve member 752, the support body 751, the second sleeve member 753, and the driven wheel 733 of the transmission unit 73 are sleeved on an end of the adjustment member 723 away from the first plate 721 in order. Thereby, the first sleeve member 752 partially passes through the second plate 722 and extends between the first plate 721 and the second plate 722. The first transmission member 735 of the transmission unit 73 is sleeved on the driven wheel 733.

The operation end 711 of the actuator 71 passes through the through hole 3315 of the connection portion 331 of the second arm 30 until the positioning flange 7131 of the connection end 713 resists the flat surface 3313 of the connecting portion 331. The joint member 76 is sleeved on the connection end 713 of the actuator 71. Two guide members 724 are received in the two blind holes 3317 in the connection portion 331 respectively. The holding unit 75, the joint member 76, and the driven wheel 733 of the transmission unit 73 are positioned between the connection portion 331 of the second arm 30 and the second plate 722 of the adjustment unit 72.

The transmission member 735 is sleeved on the driving wheel 731 of the transmission unit 73, and the support member 74 is fixed to the connection portion 331 of the second arm 30. The second driving member 78 is fixed on the support member 74, and the output shaft (not shown) thereof is received in the driving wheel 731. The first driving member 77 is fixed on the second plate 722 of the adjustment unit 72 and the output shaft (not shown) thereof is received in the joint member 76. Thereby, the actuator assembly 70 is assembled to the second arm 30. The second plate 722 of the adjustment unit 72 is capable of sliding with the adjustment member 723 relative to the second arm 30. The actuator assembly 70 is fixed on the second end 33 of the second arm 30.

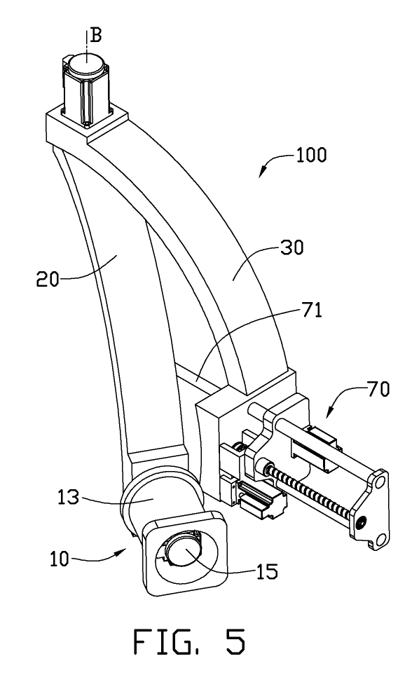

In use, the fixing member 13 of the pivotal assembly 10 is fixed to an actuator unit, such as a drill press, grinder, or other. The driving member 15 of the pivotal assembly 10 rotates the first arm around the first axis “A”, and the second arm 30 rotates with the first arm 20 simultaneously. The driving member 53 of the rotation assembly 50 rotates the second arm 30 around the second axis “B” relative to the first arm 20, and the limit to the extent of possible movement is shown in FIG. 5.

When directed to perform operation on the object, the actuator 71 is driven by the first driving member 77 via the joint member 76, thereby performing desired operations. When the distance between the operation end 711 of the actuator 71 and the curved surface 3311 of the connection portion 331 of the second arm 30 requires adjustment, the second driving member 78 is turned on and drives the adjustment member 723 of the adjustment unit 72 to rotate by means of the transmission unit 73. Since the adjustment member 723 is a threaded bar as shown in the illustrated embodiment, the second plate 722 slides along the guide members 724 to move closer to or away from the first plate 721. Furthermore, the distance between the operation end 711 of the actuator 71 and the curved surface 3311 of the connection portion 331 of the second arm 30 is changed when the actuator 71 slides with the second plate 722.

In the manipulator arm mechanism 100, the operation end 711 of the actuator 71 is capable of moving in a curved plane. Since the limit to the extent of possible movement is shown in FIG. 5, the motion trajectory of the operation end 711 of the actuator 71 is a sphere with a segment.

The first arm 20 and the second arm 30 with the curved structures may facilitate the actuator 71 to bypass an obstacle more easily when operating on the object. Furthermore, no more arms are needed and a simpler structure is achieved.

The operation end 711 of the actuator 71 is capable of moving in the curved plane, therefore, the actuator 71 does not need to be adjusted frequently to adapt to a different distance between the operation end 711 and the object, and can be easily operated. Furthermore, the manipulator arm mechanism 100 is adapted for objects of different size.

Alternatively, the first arm 20 and the second arm 30 may be connected in another way to cooperatively form other shapes, such as an “S” shape. The first arm 20 and the second arm 30 may also have a wave, stepped, or other shapes. The angle between the first axis “A” and the second axis “B” may be 30°, 45°, 60° or other angles. One of the first arm 20 and the second arm 30 may be straight, and the other curved.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A manipulator arm mechanism, comprising:
a first arm comprising a first end and a second end opposite to the first end;
a pivot shaft connected to the first end of the first arm, the pivot shaft having a first axis;
a second arm comprising a first end rotatably connected to the second end of the first arm and a second end opposite to the first end; and
an actuator connected to the second end of the second arm;
wherein the second arm rotates around a second axis; at least one of the first arm and the second arm is curved, and an angle between the first axis and the second axis is between 0° to 180°.

2. The manipulator arm mechanism of claim 1, further comprising a first driving member and an adjustment unit connected to the second end of the second arm, wherein the first driving member is fixed on the adjustment unit and connected to the actuator; the actuator moves with the adjustment unit relative to the second arm.

3. The manipulator arm mechanism of claim 2, wherein the adjustment unit comprises a first plate, a second plate, at least one guiding member, and an adjustment member, a first end of the guiding member is fixed on the first plate, and a second end of the guiding member passes through the second plate; a first end of the adjustment member is rotatably supported by the first plate, and a second end of the adjustment member passes through and is received in the second plate.

4. The manipulator arm mechanism of claim 3, further comprising a second driving member and a transmission unit, wherein the second driving member drives the adjustment member of the adjustment unit to move relative to the second plate via the transmission unit.

5. The manipulator arm mechanism of claim 4, wherein the transmission unit comprises a driving wheel, a driven wheel, and a transmission member; the transmission member is sleeved on both the driving wheel and the driven wheel, the driving wheel is connected to the second driving member, and the driven wheel is connected to the adjustment member of the adjustment unit.

6. The manipulator arm mechanism of claim 1, wherein each of the first arm and the second arm has a curved structure.

7. The manipulator arm mechanism of claim 6, wherein the central angles of the first arm and of the second arm are both 90°, such that the first arm and the second arm cooperatively form a semicircle when the second end of the first arm and the first end of the second arm are connected to each other.

8. The manipulator arm mechanism of claim 1, further comprising a pivotal assembly, wherein the pivotal assembly comprises a fixing member and a driving member, and the first arm is rotated by the driving member relative to the fixing member.

9. A manipulator arm mechanism, comprising:
a first arm comprising a first end and a second opposite to the first end;
a pivotal assembly comprising a fixing member and connected to the first end of the first arm;
a second arm comprising a first end rotatably connected to the second end of the first arm and a second end opposite to the first end; and
an actuator connected to the second end of the second arm;
wherein at least one of the first arm and the second arm is curved, the first arm is capable of rotating in a specific direction relative to the fixing member of the pivotal assembly, and the second arm is capable of rotating in another specific direction relative to the first arm.

10. The manipulator arm mechanism of claim 9, further comprising a first driving member and an adjustment unit connected to the second end of the second arm, wherein the first driving member is fixed on the adjustment unit and connected to the actuator; the actuator moves with the adjustment unit relative to the second arm.

11. The manipulator arm mechanism of claim 10, wherein the adjustment unit comprises a first plate, a second plate, at least one guiding member, and an adjustment member, a first end of the guiding member is fixed on the first plate, and a second end of the guiding member passes through the second plate; a first end of the adjustment member is rotatably supported by the first plate, and a second end of the adjustment member passes through and engages with the second plate.

12. The manipulator arm mechanism of claim 11, further comprising a second driving member and a transmission unit, wherein the second driving member moves the adjustment member of the adjustment unit relative to the second plate via the transmission unit.

13. The manipulator arm mechanism of claim 12, wherein the transmission unit comprises a driving wheel, a driven wheel, and a transmission member, the transmission member sleeved on both the driving wheel and the driven wheel, the driving wheel connected to the second driving member and the driven wheel connected to the adjustment member of the adjustment unit.

14. The manipulator arm mechanism of claim 9, wherein each of the first arm and the second arm has a curved structure.

15. The manipulator arm mechanism of claim 14, wherein the central angles of the first arm and of the second arm are both 90°, such that the first arm and the second arm cooperatively form a semicircle when the second end of the first arm and the first end of the second arm are connected to each other.
